(19) United States
(12) Patent Application Publication
(10) Pub. No.: US 2014/0226577 A1
(43) Pub. Date: Aug. 14, 2014

(54) RANGING METHOD IN WIRELESS COMMUNICATION SYSTEM AND DEVICE THEREFOR

(71) Applicants: Jin Lee, Anyang-si (KR); In Uk Jung, Anyang-si (KR); Gi Won Park, Anyang-si (KR); Young Soo Yuk, Anyang-si (KR); Jeong Ki Kim, Anyang-si (KR)

(72) Inventors: Jin Lee, Anyang-si (KR); In Uk Jung, Anyang-si (KR); Gi Won Park, Anyang-si (KR); Young Soo Yuk, Anyang-si (KR); Jeong Ki Kim, Anyang-si (KR)

(73) Assignee: LG ELECTRONICS INC., Seoul (KR)

(21) Appl. No.: 14/111,136

(22) PCT Filed: Feb. 9, 2012
(86) PCT No.: PCT/KR12/00948

§ 371 Date: Oct. 10, 2013

Related U.S. Application Data
(60) Provisional application No. 61/476,317, filed on Apr. 17, 2011.

(51) Int. Cl. H04W 24/02; H04L 5/00

(52) U.S. Cl. CPC H04W 24/02; H04L 5/0053
USPC 370/329; 370/328

(57) ABSTRACT

Provided are a ranging method in a wireless communication system and a device therefor. A plurality of M2M (machine-to-machine) devices transmit ranging codes, and a base station determines whether a network surge has occurred based on the received ranging codes. When network surge occurs, the base station transmits a network surge indicator and a network surge ranging parameter to a plurality of M2M devices.

### BACKGROUND OF THE INVENTION

### 1. Field of the Invention

The present invention relates to wireless communications, and more particularly, to a ranging method and apparatus in a wireless communication system.

2. Related Art

The institute of electrical and electronics engineers (IEEE) 802.16e standard was adopted in 2007 as a sixth standard for international mobile telecommunication (IMT)-2000 in the name of ‘WMAN-OFDMA TDD’ by the ITU-radio communication sector (ITU-R) which is one of sectors of the international telecommunication union (ITU). An IMT-advanced system has been prepared by the ITU-R as a next generation (i.e., 4th generation) mobile communication standard following the IMT-2000. It was determined by the IEEE 802.16 working group (WG) to conduct the 802.16m project for the purpose of creating an amendment standard of the existing IEEE 802.16e as a standard for the IMT-advanced system. As can be seen in the purpose above, the 802.16m standard has two aspects, that is, continuity from the past (i.e., the amendment of the existing 802.16e standard) and continuity to the future (i.e., the standard for the next generation IMT-advanced system). Therefore, the 802.16m standard needs to satisfy all requirements for the IMT-advanced system while maintaining compatibility with a mobile WiMAX system conforming to the 802.16e standard.

There is ongoing development on the IEEE 802.16p standard optimized for machine-to-machine (M2M) communication based on the IEEE 802.16e standard and the IEEE 802.16m standard. The M2M communication can be defined as an information exchange performed between a subscriber station and a server or between subscriber stations in a core network without any human interaction. In the IEEE 802.16p standard, there is an ongoing discussion on enhancement of medium access control (MAC) of the IEEE 802.16 standard and a minimum change of an orthogonal frequency division multiple access (OFDMA) physical layer (PHY) in licensed bands. Due to the discussion on the IEEE 802.16p standard, a wide area wireless coverage is required in the licensed band, and a scope of applying automated M2M communication can be increased for an observation and control purpose.

When accessing a network, requirements demanded by many M2M applications are significantly different from requirements for human-initiated or human-controlled network access. The M2M application can include vehicular telematics, healthcare monitoring of bio-sensors, remote maintenance and control, smart metering, an automated service of a consumer device, etc. The requirements of the M2M application can include very lower power consumption, larger numbers of devices, short burst transmission, device tampering detection and reporting, improved device authentication, etc.

Ranging implies a process for maintaining quality of radio frequency (RF) communication between the UE and the BS. According to the ranging, a timing offset, a frequency offset, and a power adjustment value can be accurately obtained, and transmission of the UE can be aligned with the BS. A plurality of M2M devices can perform contention-based ranging with each other. The plurality of M2M devices may belong to an M2M group. M2M devices belonging to the same M2M group share a criterion of the same M2M service application and/or the same M2M user.

A situation in which a great number of M2M devices simultaneously transmit uplink data to the BS may occur according to a characteristic of M2M communication. This can be called a network surge. In particular, there is a high possibility that the network surge occurs when M2M devices which serve for the same M2M application simultaneously transmit uplink data to the BS.

There is a need for a method for effectively performing ranging when a network surge occurs.

### SUMMARY OF THE INVENTION

The present invention provides a ranging method and apparatus in a wireless communication system. The present invention also provides a method of determining an occurrence of a network surge by a machine to machine (M2M) device or a base station.

In an aspect, a method for ranging by a base station in a wireless communication system is provided. The method includes receiving ranging codes from a plurality of machine-to-machine (M2M) devices, determining whether a network surge occurs based on the received ranging codes, and if the network surge occurs, transmitting a network surge indicator and a network surge ranging parameter to the plurality of M2M devices.

Whether the network surge occurs may be determined based on a ranging retrial number received from each of the M2M devices.

The network surge may occur when the ranging retrial number greater than or equal to a specific threshold is received from N or more M2M devices for a specific time period.

The ranging trial number may be received through a ranging request message.

The ranging request message may be a media access control (MAC) message.

Whether the network surge occurs may be determined based on whether the ranging codes received from the plurality of M2M devices are successfully received.

The network surge may occur when the ranging codes are not successfully received from N or more M2M devices during a specific time period.

The network surge indicator and the network surge ranging parameter may be transmitted in a broadcast manner.

The network surge indicator may indicate that the network surge occurs.

The network surge ranging parameter may include at least one of a scaling factor and a size of a network surge ranging backoff window.

The size of the network surge ranging backoff window may be greater than a size of a normal ranging backoff window.

The network surge ranging parameter may include information indicating a start point for applying the scaling factor and the size of the network surge ranging backoff window.

The network surge ranging parameter may include additional ranging resource allocation information for M2M device.

In another aspect, a method for ranging by a machine-to-machine (M2M) device in a wireless communication system is provided. The method includes predicting whether a network surge occurs, if it is predicted that the network surge occurs, receiving a network surge ranging parameter from a base station, and trying the ranging to the base station based on the network surge ranging parameter.

The network surge indicator and the network surge ranging parameter may be received in a broadcast manner.

Ranging can be effectively tried even if a network surge occurs.

### BRIEF DESCRIPTION OF THE DRAWINGS

FIG. 1 shows a wireless communication system.

FIG. 2 shows a basic M2M service system architecture.

FIG. 3 shows an advanced M2M service system architecture.

FIG. 4 shows an example of an IEEE 802.16e frame structure.

FIG. 5 shows an example of an IEEE 802.16m frame structure.

FIG. 6 shows an example of a ranging process of IEEE 802.16e.

FIG. 7 shows an example of a ranging process of IEEE 802.16m.

FIG. 8 shows an example of a ranging method according to an embodiment of the present invention.

FIG. 9 shows an example of a ranging method according to another embodiment of the present invention.

FIG. 10 shows an example of a ranging method according to another embodiment of the present invention.

FIG. 11 shows an example of a ranging method according to another embodiment of the present invention.

FIG. 12 is a block diagram showing wireless communication system to implement an embodiment of the present invention.

### DESCRIPTION OF EXEMPLARY EMBODIMENTS

A technology below can be used in a variety of wireless communication systems, such as code division multiple access (CDMA), frequency division multiple access (FDMA), time division multiple access (TDMA), orthogonal frequency division multiple access (OFDMA), and single carrier frequency division multiple access (SC-FDMA). CDMA can be implemented using radio technology, such as universal terrestrial radio access (UTRA) or CDMA2000. TDMA can be implemented using radio technology, such as global system for mobile communications (GSM)/general packet radio service (GPRS)/enhanced data rates for GSM evolution (EDGE). OFDMA can be implemented using radio technology, such as IEEE 802.11(Wi-Fi), IEEE 802.16(WiMAX), IEEE 802-20, or Evolved UTRA (E-UTRA). IEEE 802.16m is the evolution of IEEE 802.16e, and it provides a backward compatibility with an IEEE 802.16e-based system. UTRA is part of a universal mobile telecommunications system (UMTS). 3rd generation partnership project (3GPP) long term evolution (LTE) is part of evolved UMTS (E-UMTS) using evolved-UMTS terrestrial radio access (E-UTRA), and it adopts OFDMA in downlink (DL) and SC-FDMA in uplink (UL). LTE-A (advanced) is the evolution of 3GPP LTE.

IEEE 802.16m is chiefly described as an example in order to clarify the description, but the technical spirit of the present invention is not limited to IEEE 802.16m.

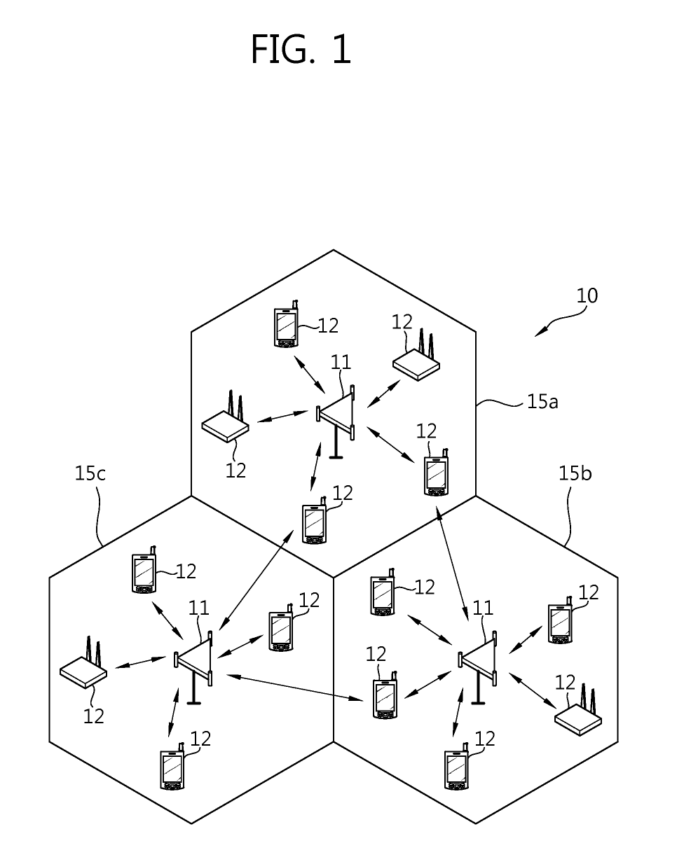

FIG. 1 shows a wireless communication system.

Referring to FIG. 1, the wireless communication system 10 includes one or more base stations (BSs) 11. The BSs 11 provide communication services to respective geographical areas (in general called ‘cells’) 15a, 15b, and 15c. Each of the cells can be divided into a number of areas (called ‘sectors’). A user equipment (UE) 12 can be fixed or mobile and may be referred to as another terminology, such as a mobile station (MS), a mobile terminal (MT), a user terminal (UT), a subscriber station (SS), a wireless device, a personal digital assistant (PDA), a wireless modem, or a handheld device. In general, the BS 11 refers to a fixed station that communicates with the UEs 12, and it may be referred to as another terminology, such as an evolved-NodeB (eNB), a base transceiver system (BTS), or an access point.

The UE generally belongs to one cell. A cell to which a UE belongs is called a serving cell. A BS providing the serving cell with communication services is called a serving BS. A wireless communication system is a cellular system, and so it includes other cells neighboring a serving cell. Other cells neighboring the serving cell are called neighbor cells. A BS providing the neighbor cells with communication services is called as a neighbor BS. The serving cell and the neighbor cells are relatively determined on the basis of a UE.

This technology can be used in the downlink (DL) or the uplink (UL). In general, DL refers to communication from the BS 11 to the UE 12, and UL refers to communication from the UE 12 to the BS 11. In the DL, a transmitter may be part of the BS 11 and a receiver may be part of the UE 12. In the UL, a transmitter may be part of the UE 12 and a receiver may be part of the BS 11.

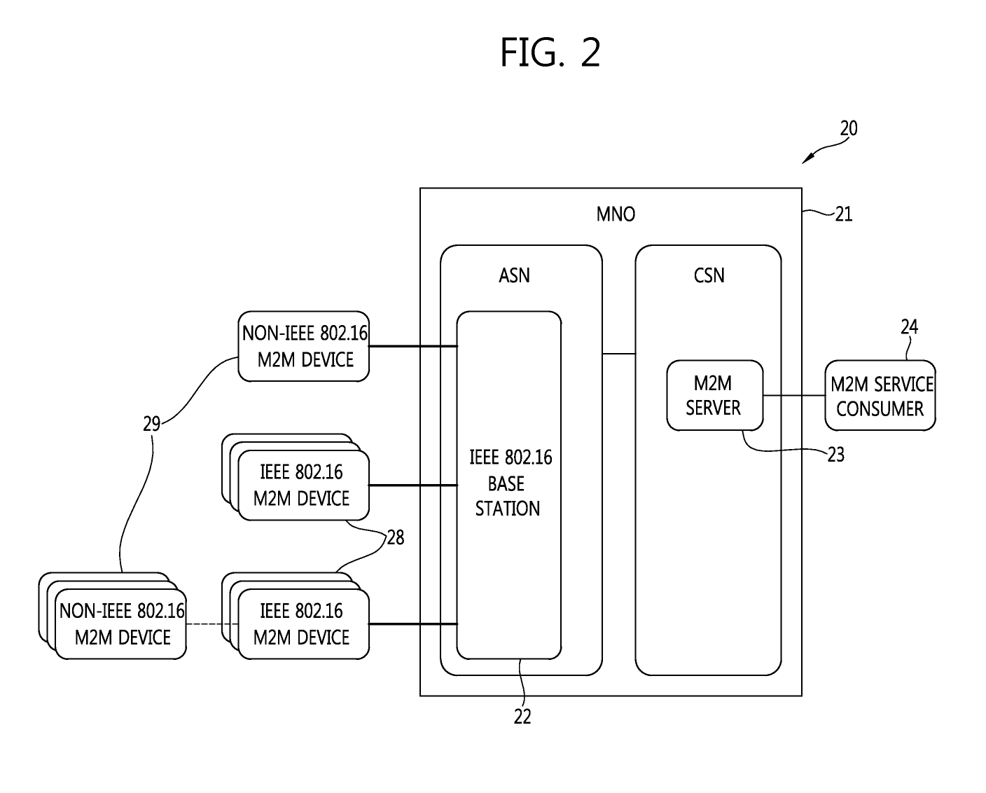

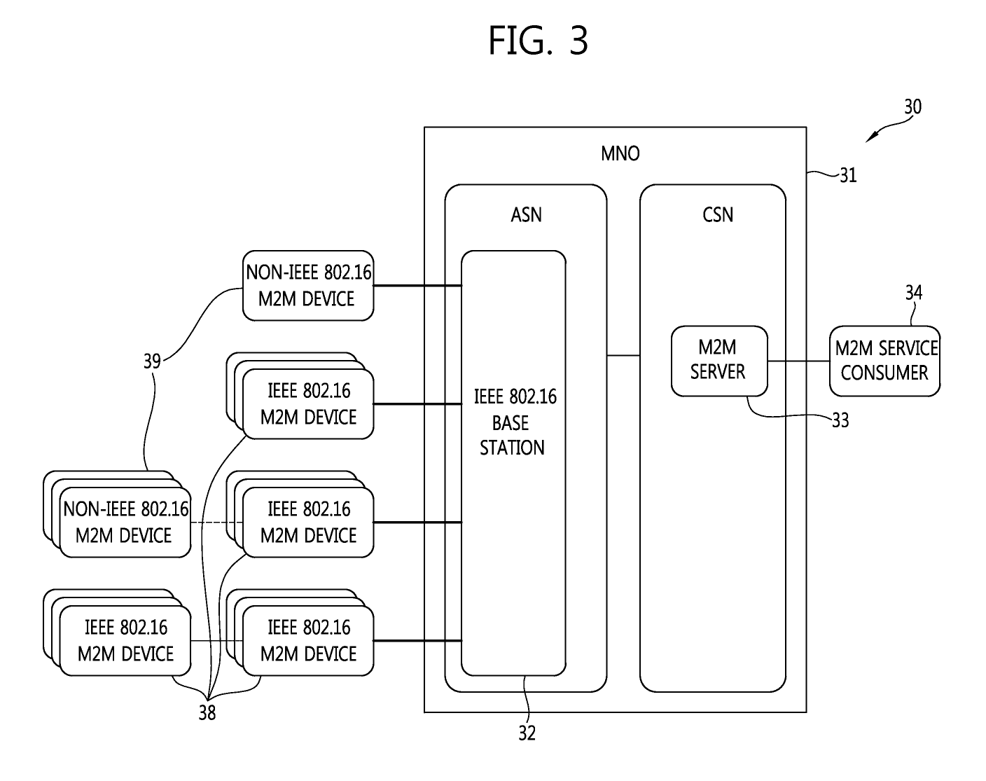

FIG. 2 and FIG. 3 show an example of system architectures of IEEE 802.16 supporting machine-to-machine (M2M) communication.

FIG. 2 shows a basic M2M service system architecture. A basic M2M service system architecture 20 includes a mobile network operator (MNO) 21, a M2M service consumer 24, at least one IEEE 802.16 M2M device (hereinafter, 802.16 M2M device) 28, and at least one non-IEEE 802.16 M2M device 29. The MNO 21 includes an access service network (ASN) and a connectivity service network (CSN). The 802.16 M2M device 28 is an IEEE 802.16 mobile station (MS) having a M2M functionality. A M2M server 23 is an entity for communicating with one or more 802.16 M2M devices 28. The M2M server 23 has an interface accessibly by the M2M service consumer 24. The M2M service consumer 24 is a user of a M2M service. The M2M server 23 may be located inside or outside the CSN, and can provide a specific M2M service to the one or more 802.16 M2M devices 28. The ASN may include an IEEE 802.16 base station (BS) 22. A M2M application operates based on the 802.16 M2M device 28 and the M2M server 23.

The basic M2M service system architecture 20 supports two types of M2M communication, i.e., M2M communication between one or more 802.16 M2M devices and a M2M server or point-to-multipoint communication between the 802.16 M2M devices and an IEEE 802.16 BS. The basic M2M service system architecture of FIG. 2 allows the 802.16 M2M device to operate as an aggregation point for a non-IEEE 802.16 M2M device. The non-IEEE 802.16 M2M device uses a radio interface different from IEEE 802.16 such as IEEE 802.11, IEEE 802.15, PLC, or the like. In this case, the non-IEEE 802.16 M2M device is not allowed to change the radio interface to IEEE 802.16.

FIG. 3 shows an advanced M2M service system architecture. In the advanced M2M service system architecture, an 802.16 M2M device can operate as an aggregation point for a non-IEEE 802.16 M2M device, and also can operate as an aggregation point for an 802.16 M2M device. In this case, in order to perform an aggregation function for the 802.16 M2M device and the non-802.16 M2M device, the radio interface can be changed to IEEE 802.16. In addition, the advanced M2M service system architecture can support a peer-to-peer (P2P) connection between 802.16 M2M devices. In this case, the P2P connection can be established on either IEEE 802.16 or another radio interface such as IEEE 802.11, IEEE 802.15, PLC, or the like.

Hereinafter, IEEE 802.16e and IEEE 802.16m frame structures will be described.

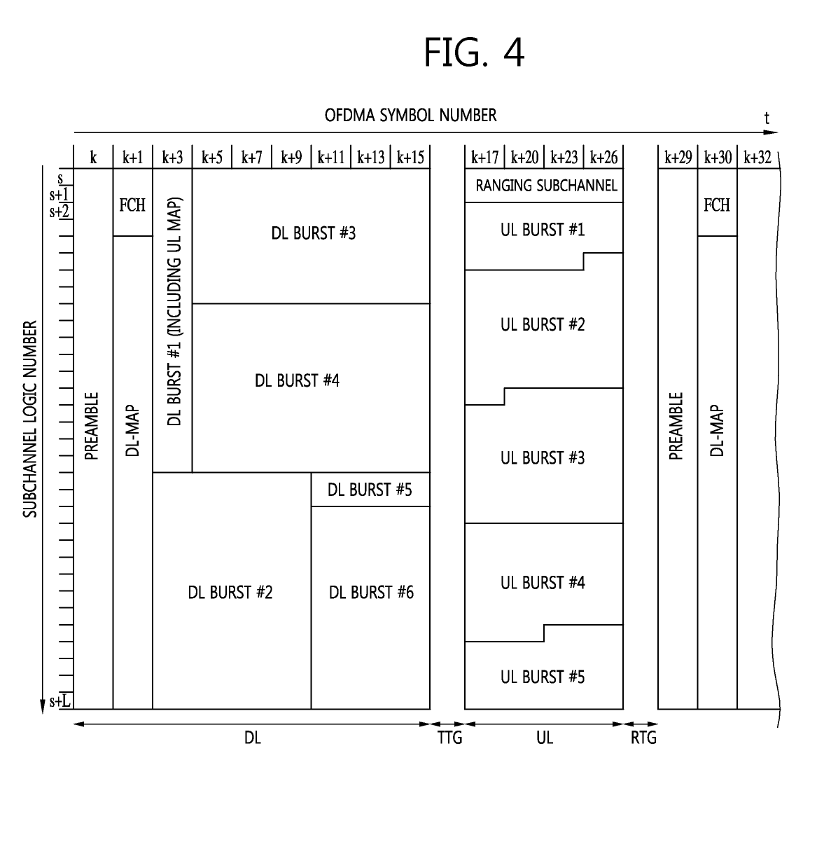

FIG. 4 shows an example of an IEEE 802.16e frame structure.

A time division duplex (TDD) frame structure of IEEE 802.16e is shown in FIG. 4. The TDD frame includes a downlink (DL) transmission period and an uplink (UL) transmission period. The DL transmission period temporally precedes the UL transmission period. The DL transmission period sequentially includes a preamble, a frame control header (FCH), a DL-MAP, a UL-MAP, and a DL burst region. The UL transmission period includes a ranging subchannel and a UL burst region. A guard time for identifying the UL transmission period and the DL transmission period is inserted to a middle portion (between the DL transmission period and the UL transmission period) and a last portion (next to the UL transmission period) of the frame. A transmit/receive transition gap (TTG) is a gap between a DL burst and a subsequent UL burst. A receive/transmit transition gap (RTG) is a gap between a UL burst and a subsequent DL burst.

A preamble is used between a BS and an MS for initial synchronization, cell search, and frequency-offset and channel estimation. The FCH includes information on a length of a DL-MAP message and a coding scheme of the DL-MAP. The DL-MAP is a region for transmitting the DL-MAP message. The DL-MAP message defines access to a DL channel. This implies that the DL-MAP message defines DL channel indication and/or control information. The DL-MAP message includes a configuration change count of a downlink channel descriptor (DCD) and a BS identifier (ID). The DCD describes a DL burst profile applied to a current MAP. The DL burst profile indicates characteristics of a DL physical channel. The DCD is periodically transmitted by the BS by using a DCD message. The UL-MAP is a region for transmitting a UL-MAP message. The UL-MAP message defines access to a UL channel. This implies that the UL-MAP message defines UL channel indication and/or control information. The UL-MAP message includes a configuration change count of an uplink channel descriptor (UCD) and also includes an effective start time of UL allocation defined by the UL-MAP. The UCD describes a UL burst profile. The UL burst profile indicates characteristics of a UL physical channel. The UCD is periodically transmitted by the BS by using a UCD message. The DL burst is a region for transmitting data sent by the BS to the MS. The UL burst is a region for transmitting data sent by the MS to the BS. The fast feedback region is included in a UL burst region of a frame. The fast feedback region is used to transmit information that requires a fast response from the BS. The fast feedback region can be used for CQI transmission. A location of the fast feedback region is determined by the UL-MAP. The location of the fast feedback region may be a fixed location in the frame, or may be a variable location.

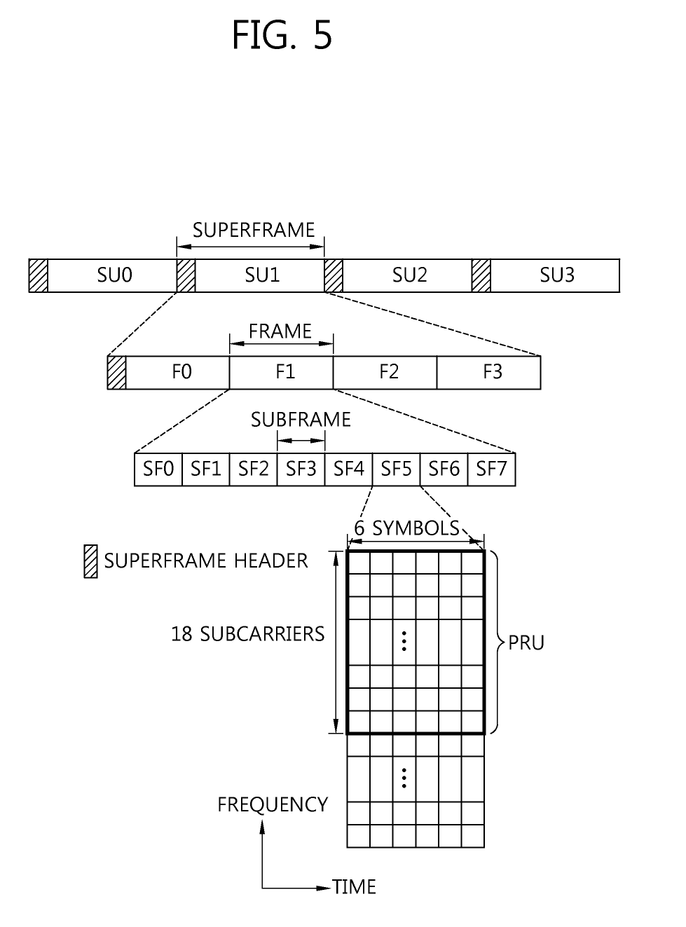

FIG. 5 shows an example of an IEEE 802.16m frame structure.

Referring to FIG. 5, a superframe (SF) includes a superframe header (SFH) and four frames F0, F1, F2, and F3. Each frame may have the same length in the SF. Although it is shown that each SF has a size of 20 milliseconds (ms) and each frame has a size of 5 ms, the present invention is not limited thereto. A length of the SF, the number of frames included in the SF, the number of SFs included in the frame, or the like may change variously. The number of SFs included in the frame may change variously according to a channel bandwidth and a cyclic prefix (CP) length.

One frame includes 8 subframes SF0, SF1, SF2, SF3, SF4, SF5, SF6, and SF7. Each subframe can be used for UL or DL transmission. One subframe includes a plurality of orthogonal frequency division multiplexing (OFDM) symbols or orthogonal frequency division multiple access (OFDMA) symbols in a time domain, and includes a plurality of subcarriers in a frequency domain. An OFDM symbol is for representing one symbol period, and can be referred to as other terminologies such as an OFDMA symbol, an SC-FDMA symbol, etc., according to a multiple access scheme. The subframe can consist of 5, 6, 7, or 9 OFDMA symbols. However, this is for exemplary purposes only, and thus the number of OFDMA symbols included in the subframe is not limited thereto. The number of OFDMA symbols included in the subframe may change variously according to a channel bandwidth and a CP length. A subframe type may be defined according to the number of OFDMA symbols included in the subframe. For example, it can be defined such that a type-1 subframe includes 6 OFDMA symbols, a type-2 subframe includes 7 OFDMA symbols, a type-3 subframe includes 5 OFDMA symbols, and a type-4 subframe includes 9 OFDMA symbols. One frame may include subframes each having the same type. Alternatively, one frame may include subframes each having a different type. That is, the number of OFDMA symbols included in each subframe may be identical or different in one frame. Alternatively, the number of OFDMA symbols included in at least one subframe of one frame may be different from the number of OFDMA symbols of the remaining subframes of the frame.

Time division duplex (TDD) or frequency division duplex (FDD) can be applied to the frame. In the TDD, each subframe is used in UL or DL transmission at the same frequency and at a different time. That is, subframes included in a TDD frame are divided into a UL subframe and a DL subframe in the time domain. In the FDD, each subframe is used in UL or DL transmission at the same time and at a different frequency. That is, subframes included in an FDD frame are divided into a UL subframe and a DL subframe in the frequency domain. UL transmission and DL transmission occupy different frequency bands and can be simultaneously performed.

A superframe header (SFH) can carry an essential system parameter and system configuration information. The SFH may be located in a first subframe in a superframe. The SFH may occupy last 5 OFDMA symbols of the first subframe. The SFH can be classified into a primary-SFH (P-SFH) and a secondary-SFH (S-SFH). The P-SFH may be transmitted in every superframe. Information transmitted on the S-SFH can be divided into 3 sub-packets, i.e., S-SFH SP1, S-SFH SP2, and S-SFH SP3. Each sub-packet can be transmitted periodically with a different periodicity. Information transmitted through the S-SFH SP1, the S-SFH SP2, and the S-SFH SP3 may be different from one another. The S-SFH SP1 may be transmitted with the shortest period, and the S-SFH SP3 may be transmitted with the longest period. The S-SFH SP1 includes information on network re-entry, and a transmission period of the S-SFH SP1 may be 40 ms. The S-SFH SP2 includes information on initial network entry and network discovery, and a transmission period of the S-SFH SP2 may be 80 ms. The S-SFH SP3 includes other important system information, and a transmission period of the S-SFH SP3 may be either 160 ms or 320 ms.

One OFDMA symbol includes a plurality of subcarriers, and the number of subcarriers is determined according to a fast Fourier transform (FFT) size. There are several types of subcarriers. A subcarrier type may include a data subcarrier for data transmission, a pilot subcarrier for various estimations, and a null carrier for a guard band and a DC carrier. A parameter for characterizing an OFDMA symbol includes BW, N_{used}, n, G, etc. BW denotes a nominal channel bandwidth. N_{used} denotes the number of subcarriers in use (including a DC subcarrier). n denotes a sampling factor. This parameter is used to determine a subcarrier spacing and a useful symbol time together with BW and N_{used}. G denotes a ratio of a CP time and a useful time.

Table 1 below shows an OFDMA parameter. The OFDMA parameter of Table 1 can equally apply to the 802.163 frame structure of FIG. 4.

TABLE 1

| Channel bandwidth, BW(MHz) | | | 5 | 7 | 8.75 | 10 | 20 |
|---|---|---|---|---|---|---|---|
| Sampling factor, n | | | 28/25 | 8/7 | 8/7 | 28/25 | 28/25 |
| Sampling frequency, Fₛ(MHz) | | | 5.6 | 8 | 10 | 11.2 | 22.4 |
| FFT size, N_{FFT} | | | 512 | 1024 | 1024 | 1024 | 2048 |
| Subcarrier spacing, Δf(kHz) | | | 10.94 | 7.81 | 9.77 | 10.94 | 10.94 |
| Useful symbol time T_{b}(μs) | | | 91.4 | 128 | 102.4 | 91.4 | 91.4 |
| G = ⅛ | Symbol time, Tₛ(μs) | | 102.857 | 144 | 115.2 | 102.857 | 102.857 |
| | FDD | Number of | 48 | 34 | 43 | 48 | 48 |
| | | OFDMA symbols | | | | | |
| | | per 5 ms frame | | | | | |
| | | Idle time(μs) | 62.857 | 104 | 46.40 | 62.857 | 62.857 |
| | TDD | Number of | 47 | 33 | 42 | 47 | 47 |
| | | OFDMA symbols | | | | | |
| | | per 5 ms frame | | | | | |
| | | TTG + RTG(μs) | 165.714 | 248 | 161.6 | 165.714 | 165.714 |
| G = 1/16 | Symbol time, Tₛ(μs) | | 97.143 | 136 | 108.8 | 97.143 | 97.143 |
| | FDD | Number of | 51 | 36 | 45 | 51 | 51 |
| | | OFDMA symbols | | | | | |
| | | per 5 ms frame | | | | | |
| | | Idle time(μs) | 45.71 | 104 | 104 | 45.71 | 45.71 |
| | TDD | Number of | 50 | 35 | 44 | 50 | 50 |
| | | OFDMA symbols | | | | | |
| | | per 5 ms frame | | | | | |
| | | TTG + RTG(μs) | 142.853 | 240 | 212.8 | 142.853 | 142.853 |
| G = ¼ | Symbol time, Tₛ(μs) | | 114.286 | 160 | 128 | 114.286 | 114.286 |
| | FDD | Number of | 43 | 31 | 39 | 43 | 43 |
| | | OFDMA symbols | | | | | |
| | | per 5 ms frame | | | | | |
| | | Idle time(μs) | 85.694 | 40 | 8 | 85.694 | 85.694 |
| | TDD | Number of | 42 | 30 | 38 | 42 | 42 |
| | | OFDMA symbols | | | | | |
| | | per 5 ms frame | | | | | |
| | | TTG + RTG(μs) | 199.98 | 200 | 136 | 199.98 | 199.98 |

| | | | | | | |
|---|---|---|---|---|---|---|
| Number of Guard | Left | 40 | 80 | 80 | 80 | 160 |
| subcarriers | Right | 39 | 79 | 79 | 79 | 159 |

| | | | | | |
|---|---|---|---|---|---|
| Number of used subcarriers | 433 | 865 | 865 | 865 | 1729 |
| Number of PRU in type-1 subframe | 24 | 48 | 48 | 48 | 96 |

Hereinafter, ranging will be described. The ranging means a series of processes for maintaining quality of RF communication between a user equipment and a base station. Accurate values of timing offset, frequency offset, and power adjustment may be acquired by the ranging, and transmission of the user equipment may be aligned with the base station.

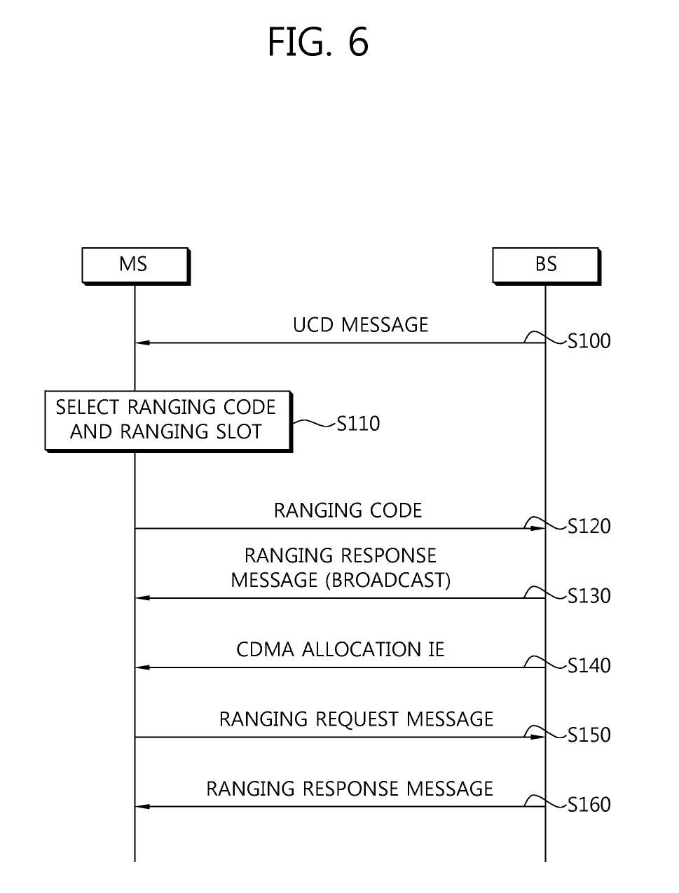

FIG. 6 shows an example of a ranging process of IEEE 802.16e.

In step S100, the MS receives a UCD message from the BS. In a system, a set of a ranging subchannels and special pseudonoise codes may be defined. In the UCD message, a subset of the special pseudonoise codes may be allocated for initial ranging, periodic ranging, or bandwidth request (BR). The BS may determine an object of codes according to a subset belonging to the codes. In the embodiment, the subset of the codes for initial ranging may be allocated in the UCD message.

In step S110, the MS selects one of the ranging codes in an appropriate subset at equal probability. Further, the MS selects one ranging slot among ranging slots usable on an uplink subframe at equal probability. When selecting one ranging slot, the MS may use random selection or random backoff. In the case of using the random selection, the MS selects one ranging slot among all usable slots in one frame through a uniform random process. In the case of using the random backoff, the MS selects one ranging slot among all usable slots in a corresponding backoff window through the uniform random process. In step S120, the MS transmits the selected ranging code to the BS through the selected ranging slot.

In step S130, in order to notify that the ranging code is successfully received, the BS broadcasts a ranging response message including the received ranging code and the ranging slot receiving the ranging code. The BS does not know which MS transmits the ranging code. By the ranging response message, the MS transmitting the ranging code may verify the ranging response message corresponding to the ranging code transmitted by the MS.

In step S140, the BS transmits a CDMA allocation information element (IE) to the MS. The BS may provide a bandwidth to which the MS transmits a ranging request message by the CDMA allocation IE. In step S150, the MS transmits the ranging request message to the BS. In step S160, the BS transmits the ranging response message to the MS, and as a result, the ranging process ends.

Meanwhile, in the ranging process of FIG. 6, the number of contention ranging retries may be defined. A timer may operate while the MS waits in order to receive the ranging response message in step S130 or step S160, or while the MS waits in order to receive the CDMA allocation IE in step S140. The timer may be terminated when the ranging code transmitted by the MS collides with the ranging code transmitted by another MS or is not accurately received from the BS. When the timer expires, the number of contention ranging retries is increased by 1, and the MS performs the ranging process again from step S100. When the ranging is continuously aborted and thus the number of contention ranging retries reaches a predetermined value, the MS searches a new channel.

Further, the UCD message may be transmitted by the BS at a predetermined period. The UCD message may include a configuration change count, and the configuration change count in the UCD message is not also changed so long as the UCD message is not changed. An UL-MAP message which allocates transmission or reception by using a burst profile defined in the UCD message having a given configuration change count has the same UCD count value as the configuration change count in a corresponding UCD message. The configuration change count in the UCD message is increased by 1 modulo 256 whenever a set of channel descriptors, that is, burst profiles is newly generated.

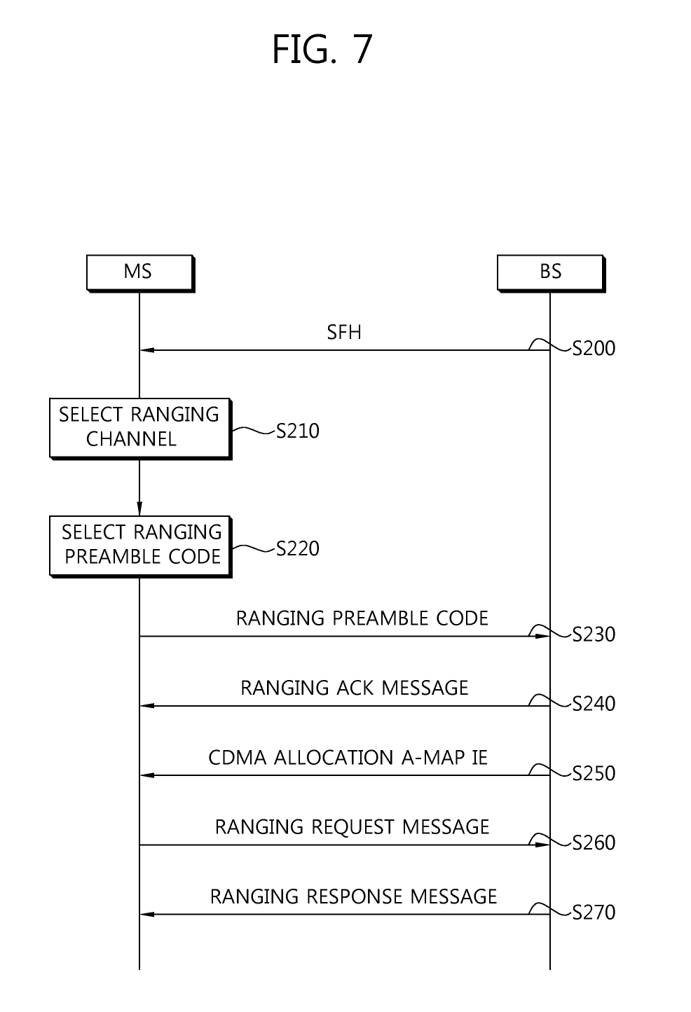

FIG. 7 shows an example of a ranging process of IEEE 802.16m.

In step S200, the MS receives an SFH from the BS. The MS may acquire system information including DL and UL parameters for an initial network entry through the SFH.

In step S210, the MS selects one ranging channel by using a random backoff. In this case, the MS selects one ranging channel among all ranging channels which are usable in a corresponding backoff window through a uniform random process. In step S220, the MS selects a ranging preamble code through the uniform random process. In step S230, the MS transmits the selected ranging preamble code to the BS through the selected ranging channel.

In step S240, the base station transmits a ranging acknowledgement (ACK) message when at least one ranging preamble code is detected. The ranging ACK message provides a response to the ranging preamble codes which are successfully received and detected with respect to all ranging opportunities in the frame. The ranging ACK message includes three kinds of ranging status responses of ‘continue’, ‘success’, and ‘abort’. When the ranging status response is ‘continue’, the MS adjusts a parameter according to the ACK message and continuously performs the ranging process. When the ranging status response is ‘abort’, the MS operates a ranging abort timer, and until the ranging abort timer expires, the ranging process is not performed.

In step S250, the BS transmits a CDMA allocation A-MAP IE to the MS. The BS may provide a bandwidth in which the MS transmits the ranging request message by the CDMA allocation A-MAP IE. In step S260, the MS transmits the ranging request message to the BS. In step S270, the BS transmits the ranging response message to the MS, and as a result, the ranging process ends.

Like the ranging process of FIG. 6, even in the ranging process of FIG. 7, the number of ranging retries may be defined. A timer may operate while the MS waits in order to receive the ranging ACK message in step S240, the CDMA allocation A-MAP IE in step S250, or the ranging response message in step S270. When the ranging ACK message, the CDMA allocation A-MAP IE, or the ranging response message is not received until the timer expires, the MS performs the ranging process all over again, and the number of ranging retries is increased by 1. When the ranging is continuously aborted and thus the number of ranging retries reaches a predetermined value, the MS retries downlink physical layer synchronization (DL PHY synchronization).

When the SFH is transmitted, a P-SFH includes S-SFH scheduling information, an S-SFH change count, an S-SFH subpacket (SP) change bitmap, and an S-SFH application hold indicator. The S-SFH change count is not changed so long as values in the S-SFH SP IE are not changed. The S-SFH change count may be changed only in a specific superframe where a remainder acquired by dividing a superframe number (SFN) by an S-SFH change cycle is 0. The S-SFH change cycle may be indicated by an S-SFH IE SP3. The changed S-SFH change cycle is maintained up to a superframe which satisfies the following condition. The S-SFH change count is increased by 1 modulo 16 whenever a value in the S-SFH IE is changed. The S-SFH SP change bitmap is coupled with the S-SFH change count to indicate a status change of the corresponding S-SFH SP IE. The S-SFH SP change bitmap may be 3 bits, and a least significant bit (LSB) is mapped in an S-SFH SP1 IE, the second significant bit is mapped in an S-SFH SP2 IE, and a most significant bit (MSB) is mapped in an S-SFH SP3 IE. In the case where any value in the S-SFH SP IE is changed, a bit value corresponding to the S-SFH SP IE changed in the S-SFH SP change bitmap is set to 1. Only when the S-SFH change count is changed, a value of the S-SFH SP change bitmap may be changed.

Further, the S-SFH SP3 IE may include a system configuration descriptor (SCD) count. The SCD count indicates a configuration change count associated with a system configuration element in a system configuration descriptor (AAI-SCD) message.

Meanwhile, the AAI-SCD message is periodically transmitted from the BS in order to define the system configuration. The configuration change count in the AAI-SCD message may be increased by 1 modulo 16 whenever information in the message is changed. The BS indicates when changed AAI-SCD message to which the SCD count in the S-SFH SP3 is applied and an offset in the P-SFH are applied through the S-SFH. After transmitting the S-SFH SP3 including the same SCD count as the configuration change count in the AAI-SCD message, the BS applies a system configuration which is changed by the AAI-SCD message associated with the SCD count in the S-SFH SP3 when the S-SFH SP3 is updated. The MS receives a recent system configuration of the AAI-SCD message associated with a current SCD count.

Hereinafter, a method for ranging according to embodiments of the present invention will be described.

A situation in which a great number of M2M devices simultaneously transmit uplink data to a BS may occur according to a characteristic of M2M communication. This is called a network surge. The M2M device may autonomously determine whether the network surge occurs. Alternatively, the BS may determine whether the network surge occurs based on information of a ranging trial of the M2M devices. However, since it is difficult for the M2M device to determine a situation of other M2M devices without an aid of the BS in general, it may be preferable that the BS determines whether the network surge occurs.

If the network surge occurs, the M2M device may try ranging by using a newly defined ranging parameter different from a ranging parameter used in a normal ranging procedure. The newly defined ranging parameter may be called a network surge ranging parameter. If the M2M device recognizes the occurrence of the network surge, the BS may transmit the network surge ranging parameter to the M2M devices through a broadcast message such as a system configuration description message (AAI-SCD), an SFH, a ranging acknowledgement message (AAI-RNG-ACK), etc. In addition, the broadcast message may include a network surge indicator. The BS may report the occurrence of the network surge to the M2M device through the network surge indicator, and the M2M device may try ranging based on the network surge ranging parameter.

For example, the network surge ranging parameter may include a size of network surge ranging backoff windows. The size of the network surge ranging backoff window may be greater than a size of a ranging backoff window used in the normal ranging procedure. This is to avoid a collision which may occur when the ranging is tried by the plurality of M2M devices in a network surge situation. For example, if the size of the normal ranging backoff window is 10, the size of the network surge ranging backoff window may be 20.

Alternatively, the network surge ranging parameter may include a scaling factor for the network surge. In the network surge situation, the size of the ranging backoff window may be increased by being multiplied by the scaling factor. For example, if the size of the normal ranging backoff window is 10 and the scaling factor is 2, the size of the ranging backoff window may be increased to 20 when the network surge occurs. With the increase in the size of the ranging backoff window, a probability of a collision which may occur when the plurality of M2M devices try the ranging may be decreased. The scaling factor may be determined by the BS, and may change according to a situation.

Alternatively, the network surge ranging parameter may include allocation information of an additional ranging resource. Alternatively, if the network surge ranging parameter includes the size of the network surge ranging backoff window or the scaling factor, the network surge ranging parameter may include information regarding a time point at which a size of a corresponding ranging backoff window is increased. This is to distribute a start time point of a ranging window of each M2M device. The time point at which the ranging backoff window is increased may be a frame corresponding to (a current superframe number mod 4). Meanwhile, it is assumed in the above description that the size of the ranging backoff window does not change even if the M2M devices collide when the ranging is tried.

Hereinafter, it will be described a ranging method according to whether a network surge is determined by an M2M device or is determined by a BS.

1) In a case where an M2M device determines whether a network surge occurs.

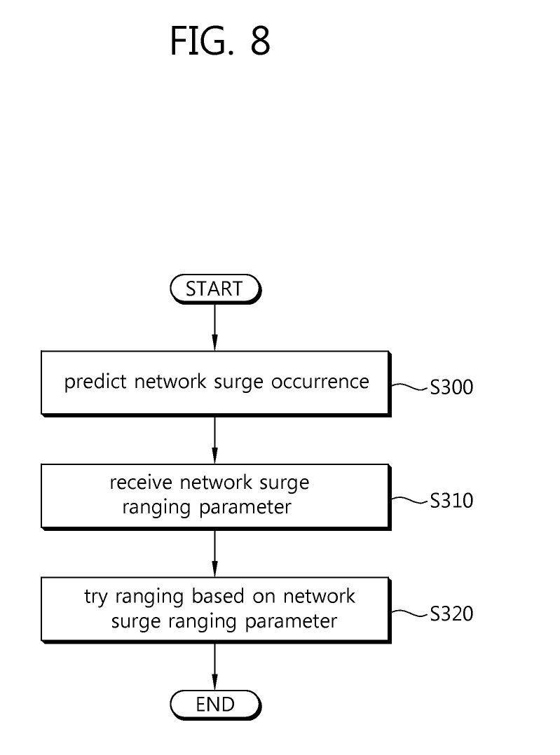

FIG. 8 shows an example of a ranging method according to an embodiment of the present invention.

In step S300, the M2M device predicts that the network surge occurs. In general, the M2M device may predict that the network surge occurs when ranging is tried for a power outage report. However, a reason for the M2M device to predict the occurrence of the network surge is not limited to a case of trying the ranging for the power outage report, and thus the occurrence of the network surge may be predicted for other reasons.

In step S310, if the M2M device predicts that the network surge occurs, the M2M device receives a network surge ranging parameter from a BS. In step S320, the M2M device tries ranging based on the network surge ranging parameter.

2) In a case where a BS determines whether a network surge occurs.

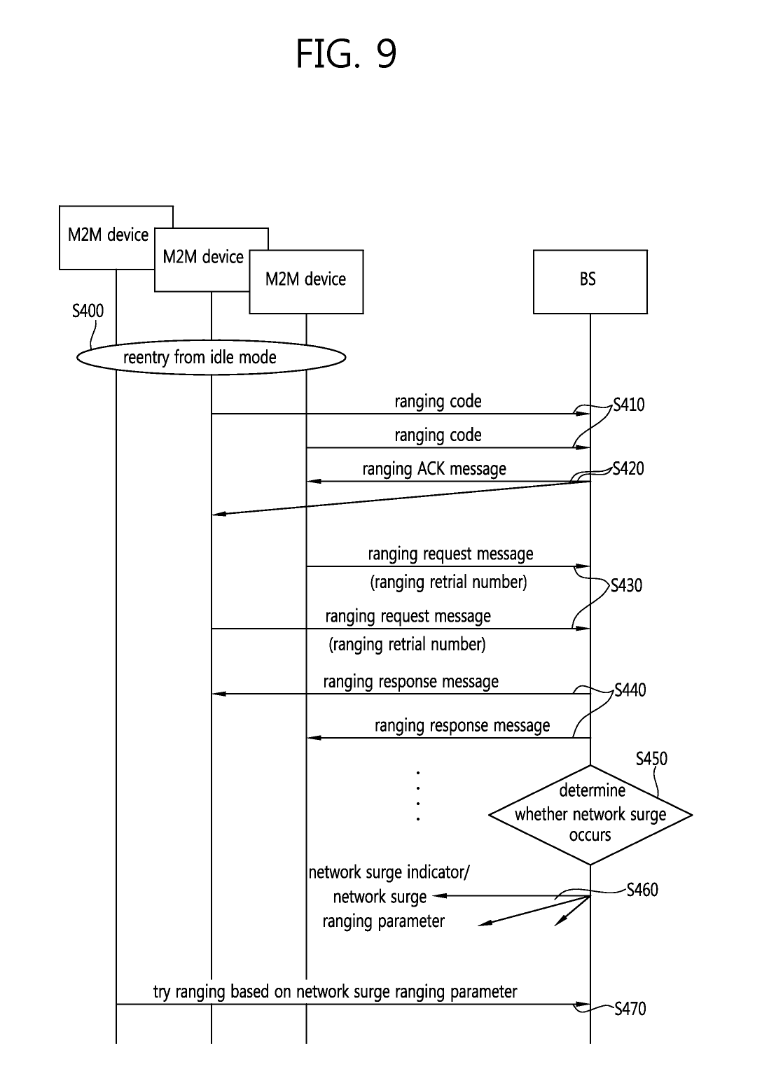

FIG. 9 shows an example of a ranging method according to another embodiment of the present invention.

In step S400, a plurality of M2M devices wake up from an idle mode and start a network re-entry. In step S410, the plurality of M2M devices transmit a ranging code to the BS. The ranging code may be a code division multiple access (CDMA) code. If the ranging code is successfully received from each of the M2M devices, in step S420, the BS transmits a ranging ACK message to an M2M device which transmits the ranging code. If the BS does not successfully receive the ranging code transmitted by the M2M device or even if the BS successfully receives the ranging code, the M2M device may not successfully receive the ranging ACK message transmitted by the BS. In this case, the M2M device may retransmit the ranging code to the BS to retry the ranging.

In step S430, the M2M device which successfully receives the ranging ACK message from the BS transmits a ranging request message to the BS. The ranging request message may include a ranging retrial number. In step S440, the BS which receives the ranging request message from the M2M devices transmits a ranging response message to the M2M device. The ranging request message and the ranging response message may be a media access message (MAC) message.

In step S450, the BS may determine whether a network surge occurs based on each M2M device's ranging retrial number included in the ranging request message. More specifically, if the ranging retrial number greater than or equal to a specific threshold is received from a plurality of M2M devices during a specific time period, the BS may determine that the network surge occurs. That is, if the threshold is K, the BS may determine that the network surge occurs when a ranging retrial number greater than or equal to a threshold K is received from N or more M2M devices during a time period T of determining whether the network surge occurs.

If it is determined that the network surge occurs, in step S460, the BS broadcasts a network surge ranging parameter to the plurality of M2M devices. The network surge ranging parameter may be broadcast through an AAI-SCD, SFH, or ranging ACK message. In addition, a network surge indicator indicating that the network surge occurs may be transmitted. Accordingly, the M2M device can know that the network surge occurs.

In addition, if the network surge occurs, the BS may allocate an additional ranging resource and broadcast this in order to avoid a collision when ranging is tried by the plurality of M2M devices. The BS may report to the M2M device an allocation of a dedicated ranging resource for the M2M device through the AAI-SCD or other types of broadcast messages. The M2M device may know a presence/absence of the additionally allocated dedicated ranging resource through a dedicated ranging resource bit of a paging message or system information. The M2M devices may try the ranging through the additionally allocated dedicated ranging resource.

Table 2 shows an example of a ranging ACK message including a network surge ranging parameter and a network surge indicator.

TABLE 2

| Field | Size (bits) | Value/Description |
|---|---|---|
| If (transmitted in a DL | | |
| resource allocated by | | |
| broadcast assignment | | |
| A-MAP IE) { | | |
| . . . | | |
| RNG-ACK bitmap | 4 | 0b0: No ranging code is |
| | | detected |
| | | 0b1: At least one ranging code is |
| | | detected |
| Network surge indicator | 1 | 0b0: Network surge occurs |
| | | 0b1: No network surge occurs |
| Network surge ranging | | 1. Network surge ranging backoff |
| parameter | | window size or scaling factor |
| | | 2. Additional ranging resource |
| | | allocation information |
| . . . | | |

Referring to Table 2, the network surge indicator included in the ranging ACK message indicates whether the network surge occurs. The network surge ranging parameter included in the ranging ACK message may include a scaling factor or a size of a network surge ranging backoff window, or may include information regarding an additional ranging resource allocation.

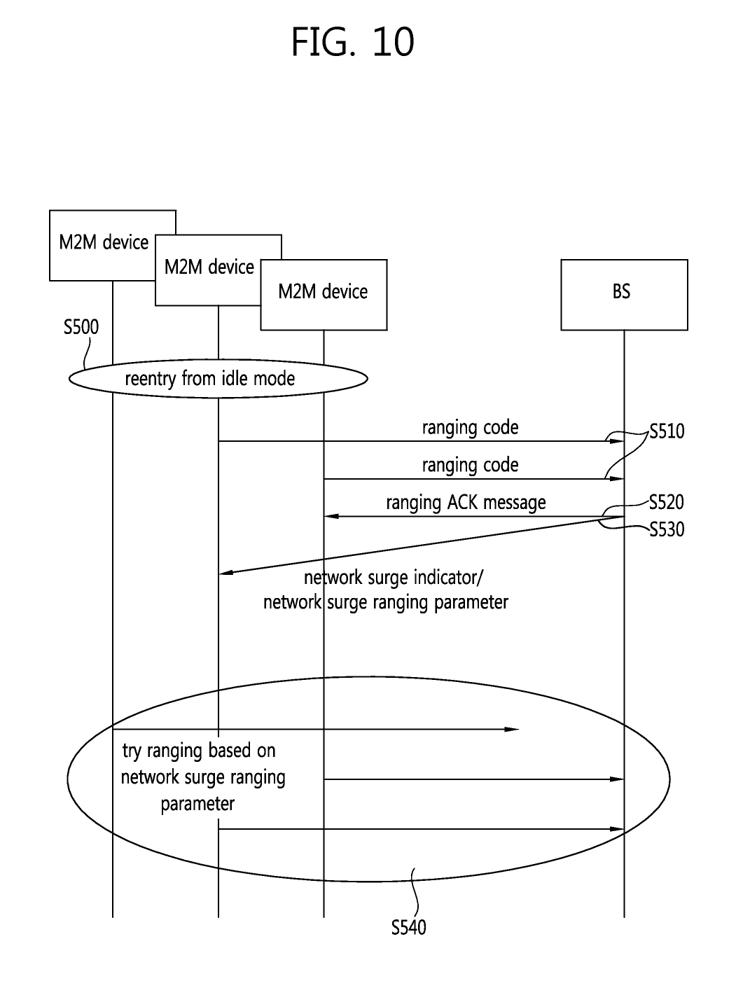

FIG. 10 shows an example of a ranging method according to another embodiment of the present invention.

In step S500, a plurality of M2M devices wake up from an idle mode and start a network re-entry. In step S510, the plurality of M2M devices transmit a ranging code to a BS. The ranging code may be a CDMA code.

In step S520, the BS transmits a ranging ACK message to the M2M device in response to the ranging code. The ranging ACK message may include whether the ranging code is successfully received from each of the M2M devices. The BS may determine that a network surge occurs if the ranging code cannot be successfully received from a specific number of (or more) M2M devices during a specific time period. That is, if the ranging codes cannot be successfully received from N or more M2M devices during a time period T of determining whether the network surge occurs, the BS may determine that the network surge occurs. When the network surge occurs, the BS may transmit a network surge indicator indicating that the network surge occurs to the M2M device by including the network surge indicator to the ranging ACK message.

In step S530, the BS transmits a network surge ranging parameter to the M2M devices. In step S540, the M2M devices try ranging on the basis of the received network surge ranging parameter.

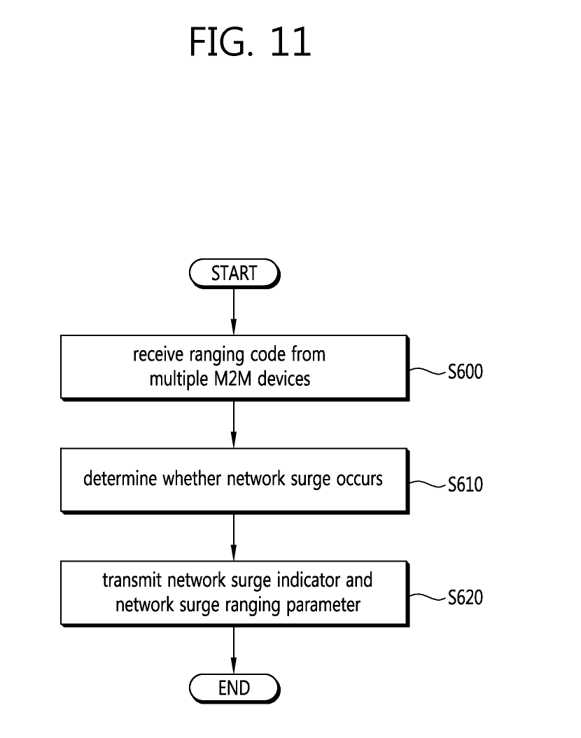

FIG. 11 shows an example of a ranging method according to another embodiment of the present invention.

In step S600, a BS receives ranging codes from a plurality of M2M devices. In step S610, the BS determines whether a network surge occurs on the basis of the received ranging codes. In step S620, if the network surge occurs, the BS transmits a network surge indicator and a network surge ranging parameter to the M2M devices.

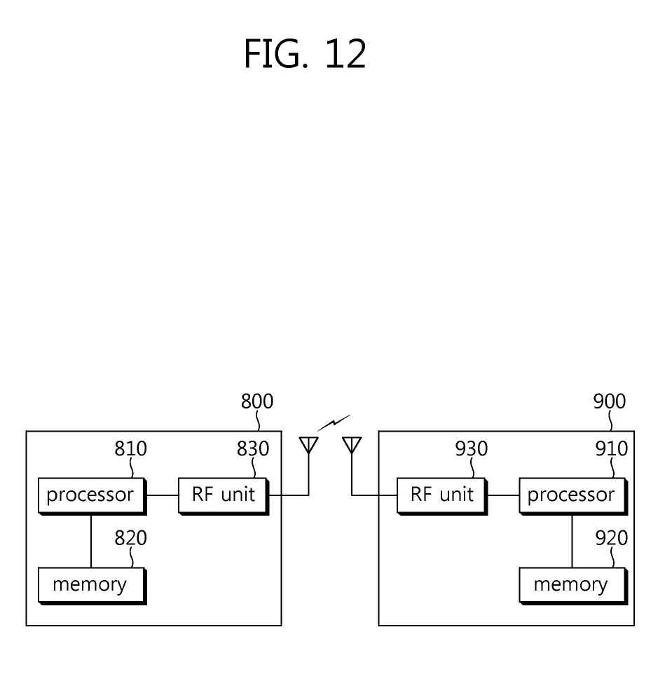

FIG. 12 is a block diagram showing wireless communication system to implement an embodiment of the present invention.

ABS800 may include a processor 810, a memory 820 and a radio frequency (RF) unit 830. The processor 810 may be configured to implement proposed functions, procedures and/or methods described in this description. Layers of the radio interface protocol may be implemented in the processor 810. The memory 820 is operatively coupled with the processor 810 and stores a variety of information to operate the processor 810. The RF unit 830 is operatively coupled with the processor 810, and transmits and/or receives a radio signal.

An M2M device 900 may include a processor 910, a memory 920 and a RF unit 930. The processor 910 may be configured to implement proposed functions, procedures and/or methods described in this description. Layers of the radio interface protocol may be implemented in the processor 910. The memory 920 is operatively coupled with the processor 910 and stores a variety of information to operate the processor 910. The RF unit 930 is operatively coupled with the processor 910, and transmits and/or receives a radio signal.

The processors 810, 910 may include application-specific integrated circuit (ASIC), other chipset, logic circuit and/or data processing device. The memories 820, 920 may include read-only memory (ROM), random access memory (RAM), flash memory, memory card, storage medium and/or other storage device. The RF units 830, 930 may include baseband circuitry to process radio frequency signals. When the embodiments are implemented in software, the techniques described herein can be implemented with modules (e.g., procedures, functions, and so on) that perform the functions described herein. The modules can be stored in memories 820, 920 and executed by processors 810, 910. The memories 820, 920 can be implemented within the processors 810, 910 or external to the processors 810, 910 in which case those can be communicatively coupled to the processors 810, 910 via various means as is known in the art.

In view of the exemplary systems described herein, methodologies that may be implemented in accordance with the disclosed subject matter have been described with reference to several flow diagrams. While for purposed of simplicity, the methodologies are shown and described as a series of steps or blocks, it is to be understood and appreciated that the claimed subject matter is not limited by the order of the steps or blocks, as some steps may occur in different orders or concurrently with other steps from what is depicted and described herein. Moreover, one skilled in the art would understand that the steps illustrated in the flow diagram are not exclusive and other steps may be included or one or more of the steps in the example flow diagram may be deleted without affecting the scope and spirit of the present disclosure.

What has been described above includes examples of the various aspects. It is, of course, not possible to describe every conceivable combination of components or methodologies for purposes of describing the various aspects, but one of ordinary skill in the art may recognize that many further combinations and permutations are possible. Accordingly, the subject specification is intended to embrace all such alternations, modifications and variations that fall within the spirit and scope of the appended claims.

What is claimed is:

1. A method for ranging by a base station in a wireless communication system, the method comprising:
receiving ranging codes from a plurality of machine-to-machine (M2M) devices;
determining whether a network surge occurs based on the received ranging codes; and
if the network surge occurs, transmitting a network surge indicator and a network surge ranging parameter to the plurality of M2M devices.

2. The method of claim 1, wherein whether the network surge occurs is determined based on a ranging retrial number received from each of the M2M devices.

3. The method of claim 2, wherein the network surge occurs when the ranging retrial number greater than or equal to a specific threshold is received from N or more M2M devices for a specific time period.

4. The method of claim 2, wherein the ranging trial number is received through a ranging request message.

5. The method of claim 4, wherein the ranging request message is a media access control (MAC) message.

6. The method of claim 1, wherein whether the network surge occurs is determined based on whether the ranging codes received from the plurality of M2M devices are successfully received.

7. The method of claim 6, wherein the network surge occurs when the ranging codes are not successfully received from N or more M2M devices during a specific time period.

8. The method of claim 1, wherein the network surge indicator and the network surge ranging parameter are transmitted in a broadcast manner.

9. The method of claim 1, wherein the network surge indicator indicates that the network surge occurs.

10. The method of claim 1, wherein the network surge ranging parameter includes at least one of a scaling factor and a size of a network surge ranging backoff window.

11. The method of claim 10, wherein the size of the network surge ranging backoff window is greater than a size of a normal ranging backoff window.

12. The method of claim 10, wherein the network surge ranging parameter includes information indicating a start point for applying the scaling factor and the size of the network surge ranging backoff window.

13. The method of claim 1, wherein the network surge ranging parameter includes additional ranging resource allocation information for M2M device.

14. A method for ranging by a machine-to-machine (M2M) device in a wireless communication system, the method comprising:
predicting whether a network surge occurs;
if it is predicted that the network surge occurs, receiving a network surge ranging parameter from a base station; and
trying the ranging to the base station based on the network surge ranging parameter.

15. The method of claim 14, wherein the network surge indicator and the network surge ranging parameter are received in a broadcast manner.
